(19) United States
(12) Patent Application Publication
(10) Pub. No.: US 2007/0268231 A1
(43) Pub. Date: Nov. 22, 2007

(54) Liquid crystal display and method for driving the same

(75) Inventors: Byung Koo Kang, Gyeongsangbuk-do (KR); Eui Tae Kim, Seoul (KR)

Correspondence Address: MORGAN LEWIS & BOCKIUS LLP, 1111 PENNSYLVANIA AVENUE NW, WASHINGTON, DC, 20004, US

(73) Assignee: LG.Philips LCD Co., Ltd.

(21) Appl. No.: 11/798,585

(22) Filed: May 15, 2007

(30) Foreign Application Priority Data
May 16, 2006 (KR) 2006-043869

(51) Int. Cl. G09G 3/36

(52) U.S. Cl. 345/100

(57) ABSTRACT

A method for driving a liquid crystal display (LCD) in which a single frame is divided into a plurality of sub-frames includes applying a first scan pulse signal and a second scan pulse signal to each gate line for each sub-frame, applying a first data signal to a data line by replying to the first scan pulse signal, applying a second data signal to the data line by replying to the second scan pulse signal, and switching on different light sources at each sub-frame, wherein the first and second scan pulse signals are simultaneously applied to different gate lines. Therefore, the LCD can transmit two scan pulse signals to a single gate line, thereby doubling a driving time of each gate line.

This application claims the benefit of Korean Patent Application No. 2006-043869, filed in Korea on May 16, 2006, which is hereby incorporated by reference.

### BACKGROUND OF THE INVENTION

1. Field of the Invention

The present invention relates to a liquid crystal display (LCD), and more particularly, to an LCD that guarantees a sufficient data charging time, and a method for driving the same.

2. Discussion of the Related Art

A variety of flat panel displays having a thickness of only several centimeters (cm) have been marketed throughout the world. A representative example of the flat panel displays is a liquid crystal display (LCD). The LCD usually has a low operation voltage and a low power-consumption, and is suitable for a mobile device. Accordingly, the LCD has been widely used in a variety of application fields such as a notebook computer, a monitor, a spaceship, and an airplane.

The LCD mainly includes a lower substrate, an upper substrate, and a liquid crystal layer formed between the lower substrate and the upper substrate. The upper substrate is provided with a gate line and a data line perpendicular to each other, thereby defining a pixel area. A thin film transistor (TFT) is formed at each crossing point between the gate line and the data line. The upper substrate also includes a plurality of shading layers to prevent the light from leaking from the gate line, the data line, and the TFT. A color filter layer is formed between the shading layers to transmit only a light signal having a specific wavelength. However, including the color filter layer in the LCD may increase total production costs of the display because the color filter requires additional production steps and costs. In order to solve the above-mentioned problem, an improved LCD has been recently developed that can be driven by a field sequential driving system.

FIG. 1 is a perspective view schematically illustrating an LCD that is driven by the field sequential driving system according to the related art. Referring to FIG. 1, the related art LCD includes a lower substrate 1, an upper substrate 2, and a liquid crystal layer (not shown) formed between the lower substrate 1 and the upper substrate 2. The lower substrate 1 is provided with the gate line 10 and the data line 20 perpendicular to each other, thereby defining a pixel area. A TFT 41 is located at a crossing point between the gate line 10 and the data line 20 and serves as a switching element. A pixel 30 includes a pixel electrode 35 and is connected to the TFT 41. A backlight unit 50 is located on a rear surface of the lower substrate 1, thereby applying a light signal to the lower substrate 1. The backlight unit 50 includes a red (R) light source 51, a green (G) light source 52, and a blue (B) light source 53. A shading layer 70 is formed on the upper substrate 2, thereby preventing the light from leaking from the gate line 10, the data line 20 and the TFT 41. A common electrode 80 is formed on the shading layer 70.

The related art LCD based on the field sequential driving system can, without using a color filter, increase a light transmission rate, temporally reproduce the color, and allow a period of the color reproduction to be equal to or less than a temporal resolution of eyesight, such that it can represent the color. The related art LCD does not require additional production costs for the color filter, while color characteristics and image implementation characteristics can be improved. However, the related art LCD still problems that will be described below.

FIG. 2 is a timing diagram schematically illustrating operations of the LCD based on the field sequential driving system according to the related art. As shown in FIG. 2, the LCD based on the field sequential driving system temporally divides a single frame into three sub-frames. A first sub-frame drives the red (R) light source, a second sub-frame drives the green (G) light source, and a third sub-frame drives the blue (B) sub-frame. Since the single sub-frame is divided into the three sub-frames and then is driven, a time period of the color reproduction is equal to or less than a temporal resolution of eyesight, thereby allowing the related art LCD to reproduce all the colors without using the color filter.

The first sub-frame charges red (R) data in a liquid crystal cell, and switches on the R light source after the lapse of a response time of the liquid crystal. The second sub-frame switches off the R light source, charges green (G) data in a liquid crystal cell, and then switches on the G light source after the lapse of a response time of the liquid crystal. The third sub-frame switches off the G light source, charges blue (B) data in a liquid crystal cell, and then switches on the B light source after the lapse of a response time of the liquid crystal. If the R light source is switched on, an image based on the R light source is displayed on the liquid crystal panel by the R light signal. If the G light source is switched on, an image based on the G light source is displayed on the liquid crystal panel by the G light signal. If the B light source is switched on, an image based on the B light source is displayed on the liquid crystal panel by the B light signal. In this way, all of the R, G, and B light sources are switched on during a single frame time, thereby displaying all the desired colors on the liquid crystal panel.

However, all of gate lines of the LCD must be driven during the single frame time. The larger the size of the LCD, the higher the number of gate lines. Thus, a time assigned to each gate line becomes shorter. The shorter the driving time of each gate, the shorter the switching-on time of the TFT connected to each gate line. As a result, data cannot be charged in a liquid crystal cell. The above-mentioned problem can be solved by enlarging a size of the TFT. However, the size of the TFT is generally limited by predetermined design rules, and is directly connected to the aperture ratio. Therefore, it is difficult to freely enlarge the size of the TFT.

### SUMMARY OF THE INVENTION

Accordingly, the present invention is directed to a liquid crystal display (LCD) and a method for driving the same that substantially obviate one or more problems due to limitations and disadvantages of the related art.

An object of the present invention is to provide an LCD that applies a scan pulse signal to a single gate line two times, thereby guaranteeing a sufficient data charging time even though a single frame is divided into a plurality of sub-frames.

Another object of the present invention is to provide a method for driving an LCD that applies a scan pulse signal to a single gate line two times, thereby guaranteeing a sufficient data charging time even though a single frame is divided into a plurality of sub-frames

Another object of the present invention is to provide an LCD that can guarantee a sufficient data charging time without enlarging the size of a thin film transistor therein.

Another object of the present invention is to provide a method for driving an LCD that can guarantee a sufficient data charging time without enlarging the size of a thin film transistor therein.

Another object of the present invention is to provide an LCD that can perform pre-charging before actual data is charged, thereby reducing a charging time of a unit pixel.

Another object of the present invention is to provide a method for driving an LCD that can perform pre-charging before actual data is charged, thereby reducing a charging time of a unit pixel.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for driving an LCD, which divides a single frame into a plurality of sub-frames, includes applying a first scan pulse signal and a second scan pulse signal to each gate line for each sub-frame, applying a first data signal to a data line by replying to the first scan pulse signal, applying a second data signal to the data line by replying to the second scan pulse signal, and switching on different light sources at each sub-frame, wherein the first and second scan pulse signals are simultaneously applied to different gate lines.

In another aspect of the present invention, the LCD, in which a single frame is divided into a plurality of sub-frames, includes a gate driving circuit for applying first and second scan pulse signals to each gate line for each the sub-frame, a data driving circuit for applying first and second data signals to a data line by replying to the first and second scan pulse signals, a light-source driving circuit for switching on different light sources according to the sub-frames, a liquid crystal panel for displaying an image upon receiving the scan pulse signals and the data signals, and a timing controller for applying data divided into several sub-frames to the data driving circuit, and controlling the gate driving circuit, the data driving circuit, and the light-source driving circuit, wherein the gate driving circuit simultaneously applies the first and second scan pulse signals to different gate lines.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a perspective view schematically illustrating a liquid crystal display (LCD) driven by a field sequential driving system according to the related art;

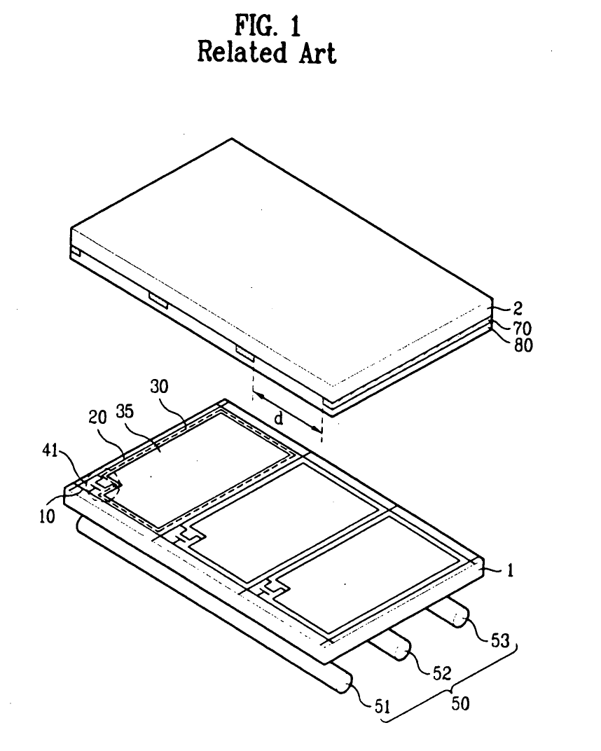

FIG. 2 is a timing diagram schematically illustrating operations of the LCD based on the field sequential driving system according to the related art;

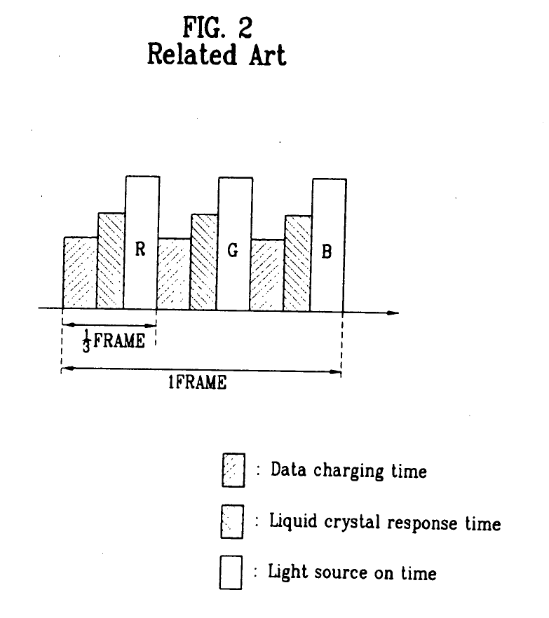

FIG. 3 is a timing diagram schematically illustrating a method for driving an LCD according to a first exemplary embodiment of the present invention;

FIG. 4 is a timing diagram schematically illustrating a method for driving an LCD according to a second exemplary embodiment of the present invention; and

FIG. 5 is a schematic diagram illustrating an LCD according to a third exemplary embodiment of the present invention.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numerals will be used throughout the drawings to refer to the same or like parts.

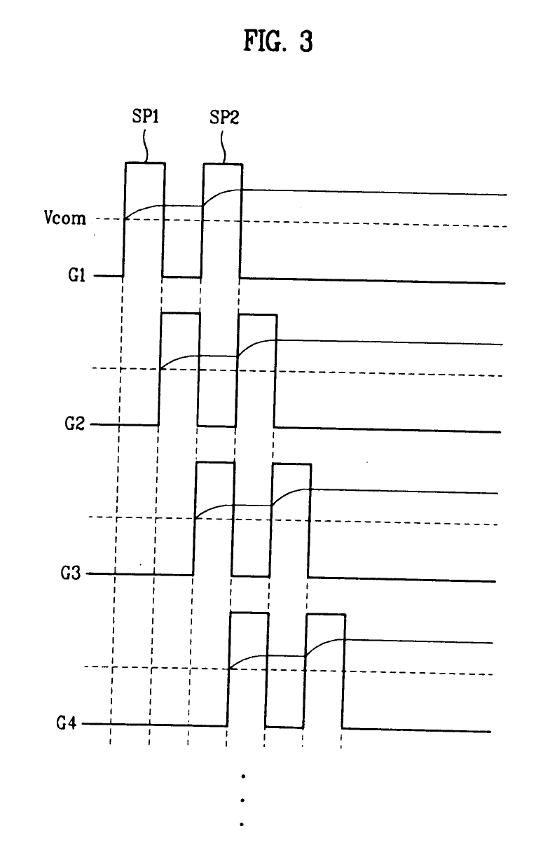

FIG. 3 is a timing diagram schematically illustrating a method for driving a liquid crystal display (LCD) according to a first exemplary embodiment of the present invention. Referring to FIG. 3, the LCD sequentially applies a scan pulse signal (SP1 and SP2) to first to fourth gate lines (G1 to G4) in order to assign a time interval corresponding to two (2) horizontal periods to a first sub-frame. The scan pulse signal (SP1 and SP2) includes a first scan pulse signal SP1 and a second scan pulse signal SP2. The second scan pulse signal SP2 is spaced apart from the first scan pulse signal SP1 by a time interval of 2 horizontal periods.

The scan pulse signal (SP1 and SP2) is applied to each of the gate lines G1 to G4 at the interval of 2 horizontal periods. A time interval between the scan pulse signals SP1 and SP2 applied to each gate line corresponds to 2 horizontal periods, such that the first scan pulse signal SP1 of the third gate line G3 and the second scan pulse signal SP2 of the first gate line G1 are simultaneously applied to the gate line. When the first scan pulse signal SP1 is applied to the first gate line G1, a first data signal is applied to the data line to act as a dummy data signal. When the second scan pulse signal SP2 is applied to the first gate line G1, a second data signal is applied to the data line to act as an actual data of a first horizontal line signal. The first scan pulse signal SP1 of the third gate line G3 and the second scan pulse signal SP2 of the first gate line G1 are simultaneously applied. Accordingly, when the actual data signal is applied to a first horizontal line, a data signal of the first horizontal line is also applied to a third horizontal line, thereby pre-charging pixel cells of the third horizontal line.

Thereafter, if the second scan pulse signal SP2 is applied to the third gate line G3, the actual data signal of the third horizontal line is applied to the data line. If the second scan pulse SP2 is applied to the third gate line G3, a third horizontal line is pre-charged, such that a sufficient charging time can be guaranteed by the second scan pulse SP2. Also, the first scan pulse signal SP1 of a fourth gate line G4 and the second scan pulse signal SP2 of the second gate line G2 are simultaneously applied. Accordingly, when the actual data signal is applied to a second horizontal line, a data signal of the second horizontal line is also applied to a fourth horizontal line, thereby pre-charging pixel cells of the fourth horizontal line. Thereafter, if the second scan pulse signal SP2 is applied to the fourth gate line G4, the actual data signal of the fourth horizontal line is applied to the data line.

In this way, if the scan pulse signals SP1 and SP2 are applied to all of the gate lines G1 to G4 according to the above-mentioned method, the actual data signal is charged in each pixel cell. After a liquid crystal response time elapses, a light source from among R, G, and B light sources is switched on, corresponding to the actual data signal charged in each pixel cell. The scan pulse signals SP1 and SP2 are applied to the gate line during the second sub-frame, and a data signal, which is from among the R, G, and B data signals and is different from a data signal supplied to the first sub-frame, is charged in each pixel cell.

If a liquid-crystal response time elapses after the data signal is charged in each pixel cell, a light source, which is from among R, G, and B light sources and corresponds to the actual data signal charged in each pixel cell, is switched on. If the scan pulse signals SP1 and SP2 are applied to the gate line during a third sub-frame, the remaining data signals from among R, G, and B data signals are charged in each pixel cell. When a liquid-crystal response time elapses, a light source corresponding to the actual data signal charged in each pixel cell is switched on.

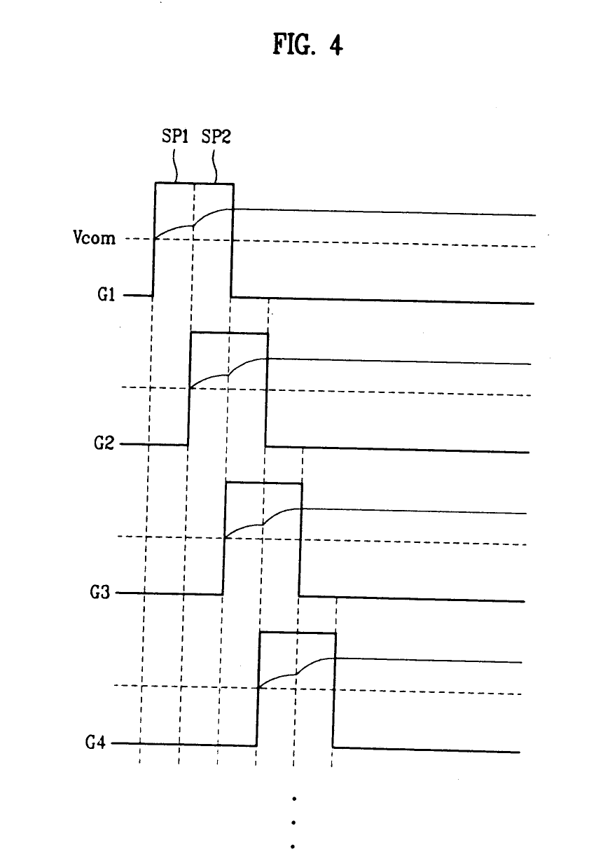

FIG. 4 is a timing diagram schematically illustrating a method for driving an LCD according to a second exemplary embodiment of the present invention. Referring to FIG. 4, the LCD sequentially applies a scan pulse signal (SP1 and SP2) to first to fourth gate lines (G1 to G4) in order to assign a time interval corresponding to a single horizontal period to a first sub-frame, in the same manner as in the first exemplary embodiment of FIG. 3. Differently from the first exemplary embodiment, the scan pulse signal (SP1 and SP2) includes a first scan pulse signal SP1 and a second scan pulse signal SP2 spaced apart from the first scan pulse signal SP1 by a time interval of a single horizontal period.

The scan pulse signal (SP1 and SP2) is applied to each of the gate lines G1 to G4 at an interval of the single horizontal period. A time interval between the scan pulse signals SP1 and SP2 applied to each gate line corresponds to the single horizontal period, such that the first scan pulse signal SP1 of the second gate line G2 and the second scan pulse signal SP2 of the first gate line G1 are simultaneously applied to the gate line. When the first scan pulse signal SP1 is applied to the first gate line G1, a first data signal is applied to the data line and acts as a dummy data signal. When the second scan pulse signal SP2 is applied to the first gate line G1, a second data signal is applied to the data line and acts as actual data of a first horizontal line signal. The first scan pulse signal SP1 of the second gate line G2 and the second scan pulse signal SP2 of the third gate line G1 are simultaneously applied. Accordingly, when the actual data signal is applied to a first horizontal line, a data signal of the first horizontal line is also applied to a second horizontal line, thereby pre-charging pixel cells of the second horizontal line.

Thereafter, if the second scan pulse signal SP2 is applied to the second gate line G2, the actual data signal of the second horizontal line is applied to the data line. Also, the first scan pulse signal SP1 of the third gate line G3 and the second scan pulse signal SP2 of the second gate line G2 are simultaneously applied. Accordingly, when the actual data signal is applied to a first horizontal line, a data signal of the second horizontal line is also applied to a third horizontal line, thereby pre-charging pixel cells of the third horizontal line. Thereafter, if the second scan pulse signal SP2 is applied to the third gate line G3, the actual data signal of the third horizontal line is applied to the data line. In this way, if the scan pulse signals SP1 and SP2 are applied to all of the gate lines G1 to G4 according to the above-mentioned method, the actual data signal is charged in each pixel cell, and a liquid crystal response time elapses, a light source, which is from among R, G, and B light sources and corresponds to the actual data signal charged in each pixel cell, is switched on.

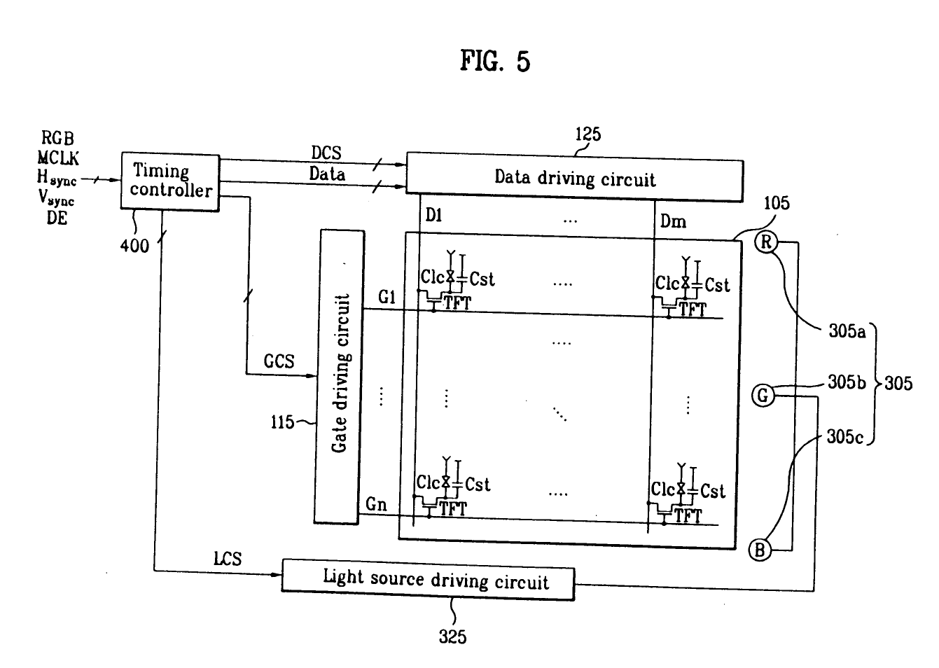

FIG. 5 is a schematic diagram illustrating an LCD according to a third exemplary embodiment of the present invention. Referring to FIG. 5, the LCD includes a liquid crystal panel 105, a gate driving circuit 115 for transmitting a scan pulse signal to N gate lines (G1 to Gn), a data driving circuit 125 for transmitting a data signal to M data lines (D1 to Dm), a light-source driving circuit 325 for driving a light source, and a timing controller 400 for generating a gate control signal (GCS) to control the gate driving circuit 115, generating a data control signal (DCS) to control the data driving circuit 125, and generating a light-source control signal (LCS) to control the light-source driving circuit 325.

The liquid crystal panel 105 is provided with N gate lines (G1 to Gn), M data lines (D1 to Dm), and a thin film transistor (TFT) formed at a crossing area between one of the gate lines (G1 to Gn) and one of the data lines (D1 to Dm). The TFT transmits the data signal of the data lines (D1 to Dm) to the liquid crystal cell in response to the scan pulse signal of the gate lines (G1 to Gn). The liquid crystal cell includes a common electrode and a pixel electrode connected to the TFT, such that it can be equivalently represented by a liquid crystal capacitor (Clc). In this case, the common electrode and the pixel electrode face each other. Moreover, the liquid crystal cell includes a storage capacitor (Cst). The storage capacitor (Cst) maintains the data signal charged in the liquid crystal capacitor (Clc) until charging the next data signal.

The gate driving circuit 115 includes a shift register (not shown). The shift register sequentially generates the scan pulse signal by replying to the gate control signal (GCS) generated from the timing controller 400. The gate driving circuit 115 sequentially transmits the scan pulse signals SP1 and SP2 to the individual gate lines (G1 to Gn), such that a time interval corresponding to a single horizontal period is assigned between the gate lines (G1 to Gn). In this case, the scan pulse signals includes the first scan pulse signal SP1 and the second scan pulse signal SP2. The second scan pulse signal SP2 is spaced apart from the first scan pulse signal SP1 by one or two horizontal periods.

The data driving circuit 125 receives a data control signal (DCS) from the timing controller 400 and then converts RGB data received from the timing controller 400 into an analog data signal, such that it transmits a data signal corresponding to the single horizontal line to the data lines (D1 to Dm) at intervals of a single horizontal period during which the scan pulse signal is applied to the gate lines (G1 to Gn). The data signal applied to the data lines (D1 to Dm) after replying to the first scan pulse signal SP1 is indicative of a data signal for pre-charging a pixel cell. The data signal applied to the data lines (D1 to Dm) after replying to the second scan pulse signal SP2 is indicative of an actual data signal for indicating a screen.

The timing controller 400 receives a main clock signal (MCLK), a data enable signal (DE), and horizontal and vertical synchronous signals (Hsync and Vsync) from an external part, and generates the data control signal (DCS), a gate control signal (GCS), and a light-source control signal (LCS) using the above-mentioned received signals, such that it controls the gate driving circuit 115, and the data driving circuit 125, and the light-source driving circuit 325. In addition, the timing controller 400 sequentially transmits RGB data signals to the data driving circuit 125 according to sub-frames. In this case, the light source 305 driven by the light-source driving circuit 325 may include an R light-source 305a, a G light-source 305b, and a B light-source 305c. The R light-source 305a, the G light-source 305b, and the B light-source 305c are sequentially switched on at each sub-frame.

As is apparent from the above description, an LCD and a method for driving the same according to the present invention can transmit two scan pulse signals to a single gate line, thereby doubling a driving time of each gate line. Because of the doubled driving time of each gate line, the LCD according to the above-described exemplary embodiments of the present invention can guarantee a sufficient data charging time even if the TFT of the present invention is smaller than that of the related art LCD based on the field sequential driving system. A single scan pulse signal from among the two scan pulse signals overlaps a scan pulse signal of another gate line, such that the LCD according to the above-described exemplary embodiments of the present invention can perform the pre-charging before actual data is charged, thereby reducing a charging time of a unit pixel. In addition, the present invention can also apply the field sequential driving method to a large-sized LCD.

It will be apparent to those skilled in the art that various modifications and variations can be made in the LCD and a method for driving the LCD of the present invention without departing from the spirit or scope of the inventions. Thus, it is intended that the present invention covers the modifications and variations of this invention provided they come within the scope of the appended claims and their equivalents.

What is claimed is:

1. A method for driving a liquid crystal display (LCD) that divides a single frame into a plurality of sub-frames, comprising:
applying a first scan pulse signal and a second scan pulse signal to each of a plurality of gate lines for each sub-frame;
applying a first data signal to a data line by replying to the first scan pulse signal;
applying a second data signal to the data line by replying to the second scan pulse signal; and
switching on a plurality of light sources at each sub-frame,
wherein the first and second scan pulse signals are simultaneously applied to different lines of the plurality of gate lines.

2. The method according to claim 1, wherein the first scan pulse signal is sequentially applied to each of the plurality of gate lines.

3. The method according to claim 2, wherein sequentially applying the first scan pulse signals to each of the plurality of gate lines includes:
sequentially applying the first scan pulse signal such that a time interval corresponding to a single horizontal period is assigned to each of the plurality of gate lines.

4. The method according to claim 1, wherein applying the second scan pulse signal is performed after a lapse of two horizontal periods after the first scan pulse signal has been applied.

5. The method according to claim 1, wherein applying the second scan pulse signal is performed after a lapse of a single horizontal period after the first scan pulse signal has been applied.

6. The method according to claim 1, wherein the second scan pulse signal applied to an i-th line (where i is a natural number) of the plurality of gate lines overlaps the first scan pulse signal applied to an (i+2)-th line of the plurality of gate lines.

7. The method according to claim 1, wherein the second scan pulse signal applied to an i-th line (where i is a natural number) of the plurality of gate lines overlaps the first scan pulse signal applied to an (i+1)-th line of the plurality of gate lines.

8. The method according to claim 1, wherein the first data signal applied to the first data line by replying to the first scan pulse signal of one gate line is equal to the second data signal applied to the second data line by replying to the second scan pulse signal of another gate line, the second scan pulse signal and the first scan pulse signal being simultaneously applied.

9. A liquid crystal display (LCD) in which a single frame is divided into a plurality of sub-frames, comprising:
a gate driving circuit for applying first and second scan pulse signals to each of the plurality of gate lines for each of the plurality of sub-frames;
a data driving circuit for applying first and second data signals to each of a plurality of data lines by replying to the first and second scan pulse signals;
a light-source driving circuit for switching on a plurality of light sources according to the plurality of sub-frames;
a liquid crystal panel for displaying an image upon receiving the scan pulse signals and the data signals; and
a timing-controller for applying data divided into several sub-frames to the data driving circuit, and controlling the gate driving circuit, the data driving circuit, and the light-source driving circuit,
wherein the gate driving circuit simultaneously applies the first and second scan pulse signals to different lines of the plurality of gate lines.

10. The LCD according to claim 9, wherein the light-source driving circuit drives at least two color light sources of the plurality of light sources.

11. The LCD according to claim 9, wherein:
after the first scan pulse signal is applied to one gate line, the gate driving circuit applies the second scan pulse signal to the same gate line.

12. The LCD according to claim 9, wherein:
after the first scan pulse signal is applied to one gate line, the gate driving circuit applies the second scan pulse signal to the same gate line after a lapse of two horizontal periods.

13. The LCD according to claim 9, wherein:
after the first scan pulse signal is applied to one gate line, the gate driving circuit applies the second scan pulse signal to the same gate line after a lapse of a single horizontal period.

14. The LCD according to claim 9, wherein the second scan pulse signal applied to an i-th line (where i is a natural number) of the plurality of gate lines overlaps the first scan pulse signal applied to an (i+2)-th line of the plurality of gate lines.

15. The LCD according to claim 9, wherein the second scan pulse signal applied to an i-th line (where i is a natural number) of the plurality of gate lines overlaps the first scan pulse signal applied to an (i+1)-th line of the plurality of gate lines.

16. The LCD according to claim 9, wherein:
the first data signal is applied to the data line by replying to the first scan pulse signal; and
the first data signal is equal to the second data signal applied to the data line by replying to the second scan pulse signal.
